(19) United States
(12) Patent Application Publication
(10) Pub. No.: US 2009/0292699 A1
(43) Pub. Date: Nov. 26, 2009

(54) Nucleotide and amino acid sequence compression

(76) Inventors: Gregory P. Knowles, Netherby (AU); Paul Gardner-Stephen, Ascot Park (AU)

Correspondence Address: Imperium Patent Works, P.O. Box 587, Sunol, CA, 94586, US

(21) Appl. No.: 11/731,143

(22) Filed: Mar. 29, 2007

Related U.S. Application Data
(60) Provisional application No. 60/787,028, filed on Mar. 29, 2006.

(51) Int. Cl. G06F 17/30

(52) U.S. Cl. 707/6; 707/104.1; 707/E17.108; 707/E17.044

(57) ABSTRACT

A biomolecular sequence database is encoded using a set of byte-aligned block codes. Some of the block codes encode a portion of a current sequence by pointing to an identical portion of another sequence. Others of the block codes are run length codes. Multiple different ways of encoding a current sequence using different ones of the block codes are determined. Dynamic programming is used to determine which one of these ways most efficiently encodes the current sequence into the shortest string of block codes. Each sequence in the database is encoded as such a string of block codes.

### CROSS-REFERENCE TO RELATED APPLICATIONS

This application is based on a hereby claims priority under 35 U.S.C. §119 from U.S. Provisional Application No. 60/787,028, filed Mar. 29, 2006, entitled “NP3: A High Utility Nucleotide Database Compression Algorithm”, by Knowles et al. The disclosure of the foregoing document is incorporated herein by reference.

### TECHNICAL FIELD

The present invention relates to data compression, and more specifically to compressing nucleotide and/or amino acid sequence information.

### SUMMARY

A biomolecular sequence database is encoded using a set of byte-aligned block codes. Some of the block codes encode a portion of a current sequence by pointing to an identical portion of another sequence. Others of the block codes are run length codes. Multiple different ways of encoding a current sequence using different ones of the block codes are determined. Dynamic programming is used to determine which one of these ways most efficiently encodes the current sequence into the shortest string of block codes. Each sequence in the database is encoded as such a string of block codes.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a method in accordance with one novel aspect.

FIG. 2 illustrates base codes and their corresponding 4-bit codes.

FIG. 3 illustrates a way that a long sequence can be broken up into a set of shorter sequences (also called segments).

FIG. 4 illustrates three sequences that share a similar string (referred to as a “redundant” string).

FIG. 5 is a table that sets forth byte-aligned block codes used to code sequences in accordance with one novel aspect.

FIG. 6 illustrates base codes and their corresponding 2-bit codes.

FIG. 7 illustrates coding costs associated with coding an exemplary sequence.

FIG. 8 is a table that sets forth the coding costs of FIG. 7.

FIG. 9 is a table that sets forth the codes used in the coding of FIG. 8.

FIG. 10 is a table that illustrates a dynamic programming method of determining a lowest cost string of codes to code the example of FIG. 7.

FIG. 11 is a table that illustrates the string of codes determined by the dynamic programming of FIG. 10.

FIG. 12 is a diagram of a searching system in accordance with a second novel aspect. The searching system employs the byte-aligned block coding dynamic programming compression method described by FIGS. 1-11.

### DETAILED DESCRIPTION

Reference will now be made in detail to some embodiments of the invention, examples of which are illustrated in the accompanying drawings.

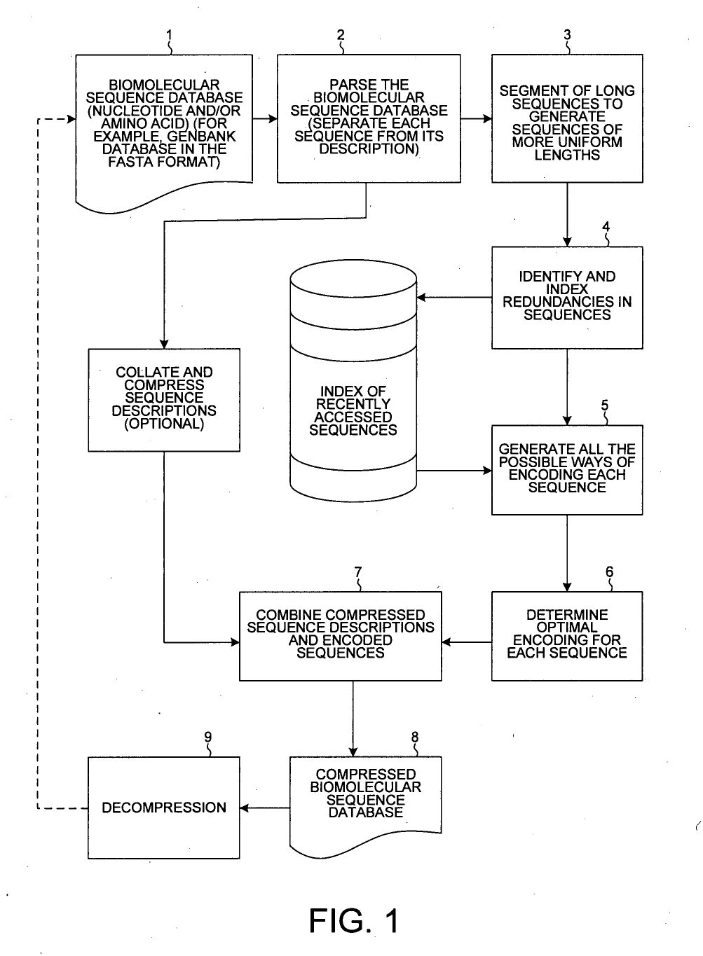

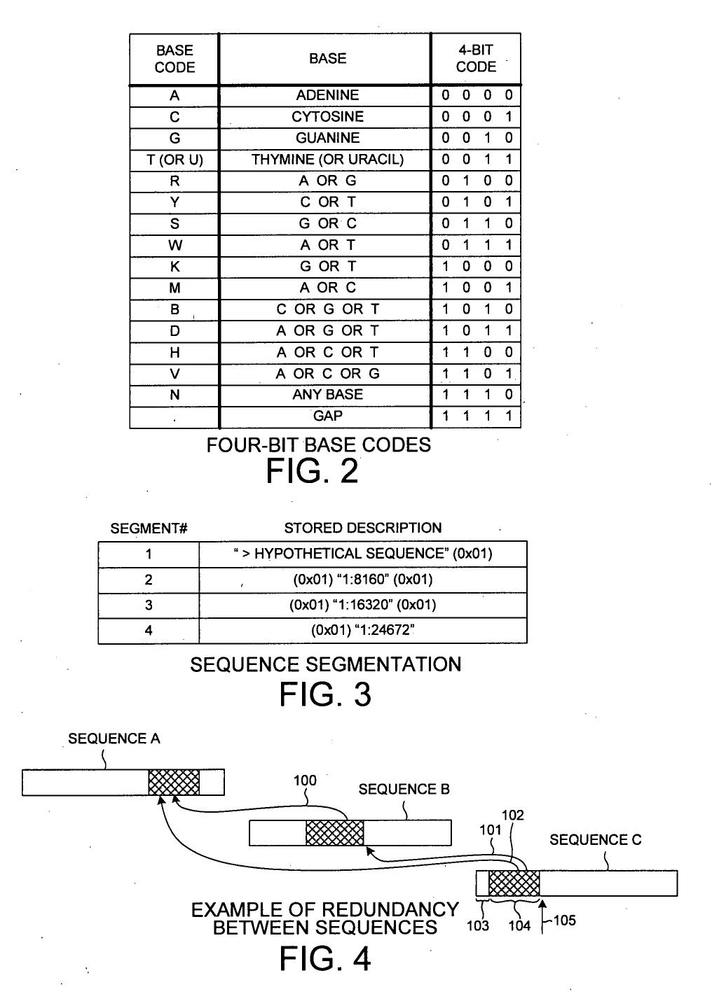

FIG. 1 illustrates a method in accordance with one novel aspect. In one example, process flow begins (step 1) with a biomolecular sequence database. The term biomolecular sequence database refers to a collection of nucleic acid base sequences and/or amino acid sequences. The biomolecular sequence database may, for example, be the entire GenBank biomolecular sequence database including both nucleic acid base (nucleotide) sequences and amino acid sequences. In the presently described specific example, however, the biomolecular sequence database is a database of sequences of nucleic acid bases. The bases are encoded using standard IUB/IUPAC text character nucleic acid base codes. Examples of these text character codes include A, C, G, T, R, Y, S, W, K, M, B, D, H, V, N and . (a period). Each text character code represents a nucleic acid base in a sequence or represents information about the nucleic acid base. FIG. 2 sets forth the various IUB/IUPAC textual base codes and what they mean. In the biomolecular sequence database, each sequence is typically stored in association with descriptive information about the sequence.

Next (step 2), the biomolecular sequence database is parsed. Each sequence within the database is separated from its associated descriptive information. Some of the sequences are longer than 8 k (8192) bases in length.

Next (step 3), sequences over 8 k bases in length are segmented into one of more pieces to create the sequences that will be used in the compression method. When a longer sequence is cut into smaller segments, a short overlap is provided at the beginning of the overlapping segment. Providing this overlap portion simplifies stitching of segments into larger sequences during searching. The overlap contributes only negligibly to the total size of the set of sequences. The segments, as well as sequences that are not segmented, are referred to here as “sequences.”

When a long sequence is segmented, the sequence description is concatenated with 0x01 and is stored with the first segment. In this situation, the /len=n tag is not removed from the sequence, because during serial decompression it is problematic to determine efficiently the length of the reassembled sequence. Descriptions of subsequent segments include a 0x01 character followed by the sequence number of the first segment, and an offset to the beginning of this segment. The “offset” here is a count of the number of bases in the assembled sequence between the beginning of the first segment and the beginning of the segment of interest. This enables an alignment which occurs in a subsequent segment to be appropriated to its host sequence. Descriptions of non-terminal segments also have a 0x01 character concatenated. This sequence segmentation procedure is used both within and between file compartments.

FIG. 3 illustrates an example of the sequence segmentation procedure for a hypothetical sequence that is divided into four segments. The first segment of a segmented sequence contains the true description of the sequence followed by a 0x01. This 0x01 character indicates that the sequence has subsequent segments. Each of the subsequent non-terminal segments (segments 2 and 3 in this example) also terminates with a 0x01 character to indicate that the sequence continues. Non-head segments (segments 2, 3 and 4 in this example) are prefixed with 0x01 to indicate that they are segments. The description data of a non-head segment identifies the head segment and includes an offset from the beginning of the head segment to the beginning of the current segment. For example, in the description data “1:8160” of the second segment, the “1” before the colon indicates that the head segment is sequence one, and the 8160 is the offset to the beginning of the second segment.

Next (step 4), the sequences output by step 3 are examined to identify identical or similar strings that are repeated either within a sequence or across multiple ones of the sequences. FIG. 4 illustrates three sequences A, B and C. In the diagram, the left end of a rectangular block represents the beginning of a sequence, whereas the right end of the block represents the end of the sequence. The cross hatched portions represent identical or similar strings of bases. Accordingly, the same string of bases is repeated in each of the three sequences A, B and C. In this example, sequence B contains a string that also occurs, in sequence A, as indicated by arrow 100. Similarly, sequence C contains the same string that occurs in both sequence A and sequence B (as indicated by arrows 101 and 102). The existence of identical or similar strings in two sequences is referred to here generally as “redundancy”. The redundancies of both sequences B and C are recorded against sequence A. This approach of recording redundancy to the farthest away host sequence serves to minimize the number of hops required to find the redundant string during decompression. Reducing the number of hops helps to reduce decompression time when extracting a random sequence from the database. In one example, the sequence alignment method called DASH (Diagonal Aggregating Search Heuristic) is used to find repeating strings in the various sequences output from step 3. For further information on the DASH method, see: U.S. patent application Ser. No. 11/019,807, entitled “Efficiently Calculating Scores For Chains of Sequence Alignments”, by Knowles et al., filed Dec. 20, 2004 (the subject matter of which is incorporated herein).

Next (step 5), once identical or similar strings are identified in the various sequences, each of the sequences is encoded using a set of byte-aligned block codes.

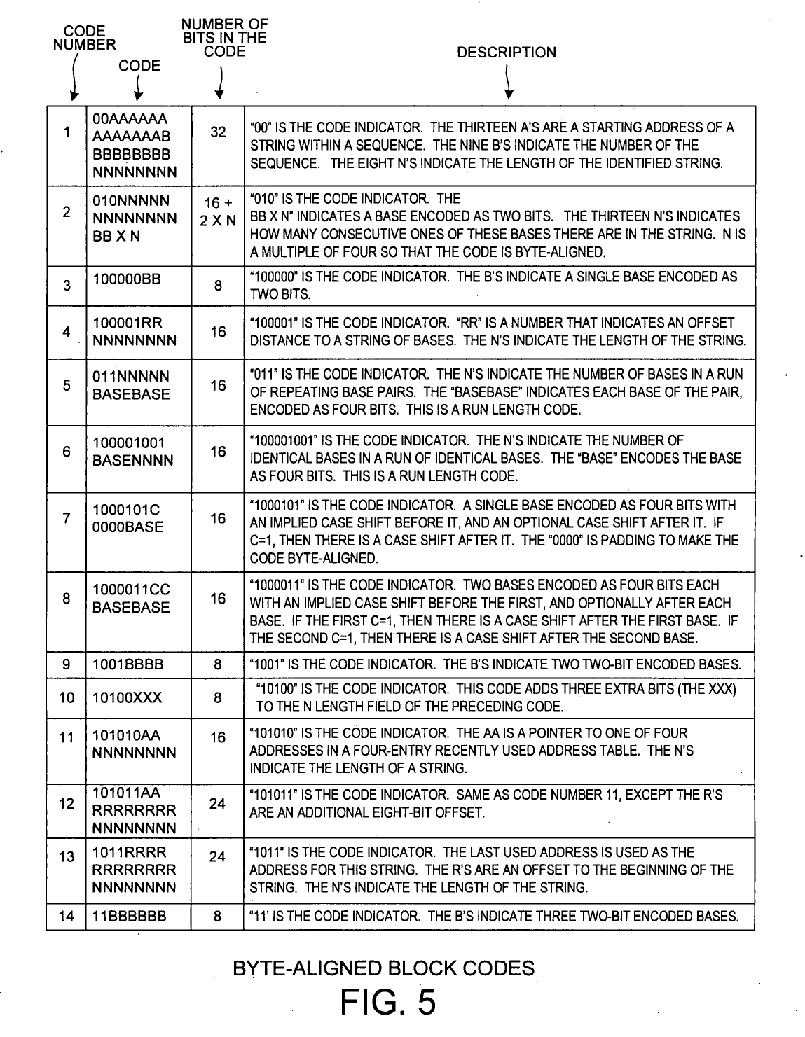

FIG. 5 is a diagram that sets forth the various block codes that are usable in this particular specific embodiment.

Code 1 is thirty-two bits (four bytes) long. The first two bits “00” are a code indicator that indicates that the code is “code 1”. The next thirteen bits are an address that points to the beginning of a redundant string within a sequence. The address is the number of bases between the beginning of the sequence referred to and the first base of the redundant string referred to. This address is indicated with “A's” in FIG. 5. The next eight bits are a sequence number of the sequence that includes the string being pointed to. The sequence number is not an absolute sequence number, but rather is encoded as a number relative to the current sequence number. The sequences output from step 3 have associated sequence numbers that increment from one sequence to the next. This sequence number in code 1 is indicated with “B's” in FIG. 5. The last eight bits of code 1 indicate the length of the string being pointed to. This length is indicated with “N's” in FIG. 5. If, for example, the string being pointed to is a string of five hundred bases, then the number N is five hundred.

Code 1 is usable to encode a portion of a current sequence to be a copy of another sequence. Consider the example of FIG. 4 and assume that sequence C is being encoded. After encoding the beginning portion 103 of sequence C, the cross hatched string portion 104 of sequence C is to be encoded. This string 104 is, however, also found in sequence A as illustrated in FIG. 4. String 104 can be encoded using code 1. The B value is identifies the sequence number of sequence A. The B value is two because sequence A is two sequences away from sequence C (the sequence being encoded). The A value is the number of bases from the beginning of sequence A to the beginning of the cross hatched redundant string in sequence A. The N is the length in bases of the redundant string in sequence A. The resulting code 1 is therefore used as the code for string 104 of sequence C.

After the encoding of a string using code 1, the address value A is adjusted to point to the next base after the recently encoded string. In the example of FIG. 4, the arrow 105 identifies the location of the adjusted address value. Once adjusted, the address value A is pushed into in a four-deep first-in-first-out (FIFO) memory within the mechanism that is performing the encoding. There is a two-bit pointer that is associated with each entry in the FIFO memory. As other address values are pushed into the FIFO, the two-bit pointer for a particular address value continues to point to its associated address value.

Codes 1, 4, 11, 12 and 13 are called “redundancy” codes. As explained above, code 1 is used to refer to another sequence in which a redundant string is found. Once the other sequence is identified, it is assumed to remain the same if codes 4, 11, 12 or 13 are used.

Code 4, for example, is usable to encode a portion of a current sequence to be a copy of a portion of another sequence, where the portion of the other sequence is offset by a number of bases from another portion of the other sequence that was just referred to. If, for example, code 1 is used to point to a portion of another sequence X, then after the use of code 1 the address value A is left pointing to the next base after the portion in sequence X. If code 4 is then used, the portion pointed to by code 4 is in the same sequence X. The two bits “RR” in code 4 are a number that indicates an offset distance to the beginning of the portion to be pointed to by code 4. This RR value therefore is the number of bases between the end of the portion pointed to by code 1 and the beginning of the portion pointed to by code 4. The eight-bit value N in code 4 indicates the length of the portion pointed to by code 4.

Code 11 is also a redundancy code. If Code 11 is used, the sequence pointed to is assumed to be the last sequence pointed to by code 1. The value AA in Code 11 is a two-bit pointer that points to one of the four address entries in the FIFO address table mentioned above. The value N indicates the length of the string that starts at the indicated address.

Code 12 is also a redundancy code. If Code 12 is used, the sequence pointed to is assumed to be the last sequence pointed to by code 1. This code is similar to code 11, except that the value R is an additional offset. The string pointed to by Code 12 therefore starts R bases away from the address found in the address table at pointer AA.

Code 13 is also a redundancy code. If code 13 is used, the sequence pointed to is assumed to be the last sequence pointed to by code 1. The last used address in the FIFO address table is used as the address. The value R is an offset from the base pointed to by this address to the beginning of the portion being pointed to. The value N is the length of the portion.

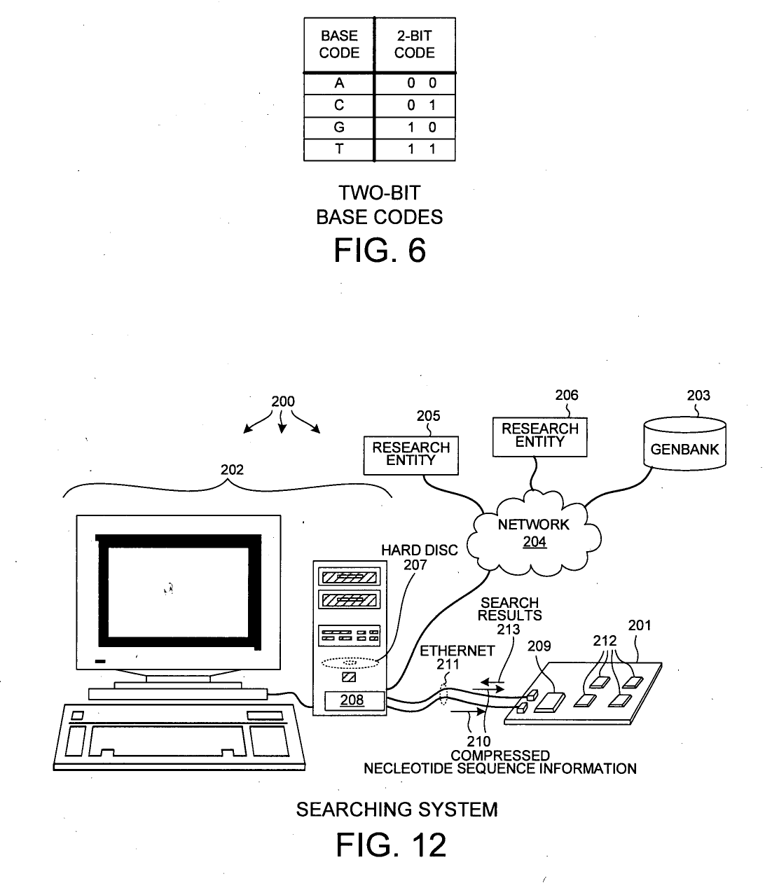

Code 2 is usable to encode an arbitrary string of bases. In code 2 there is no reference sequence being pointed to. Each base in the current sequence to be encoded is simply encoded as two-bits. FIG. 6 sets forth the two-bit codes that are usable. The resulting code 2 is therefore sixteen bits plus two times N bits, where N is the number of bases in the string being coded. The 13-bit value N in the code is a number that indicates the number of bases in the string. N must be a multiple of four. This rule is enforced so that the resulting code will be byte-aligned. Having the codes all start at byte boundaries simplifies decompression because the beginning of the codes can be located without performing shifting operations.

Code 3 encodes a single base as two bits. As in code 2, there is no reference sequence being pointed to. The base in the current sequence to be encoded is simply encoded using an appropriate one of the two-bit codes of FIG. 6.

Codes 5 and 6 are run length codes. Code 5 encodes a run of repeating pairs of base pairs. In FIG. 5, the “BASE” in “BASEBASE” indicates a base of the base pair. Each such “BASE” is encoded as four bits using the four-bit codes of FIG. 2. The value N indicates the length of the run. This code is usable, for example, to encode a string such as “GCGCGCGCGCGC”. The base pair is “GC”. The length of the run is twelve.

Code 6 is usable to encode a run of identical bases. The “BASE” in FIG. 5 encodes the base as four bits using the four-bit codes in FIG. 2. The value N indicates the length of the run.

In some biomolecular sequence databases, the case of a character is used to communicate information. For example, using an upper case for a text character may indicate a protein, whereas using a lower case of the same text character may indicate a DNA sequence. Case can also be used to communicate other information depending on the database format being used.

Code 7 is usable to encode a single base as a four-bit code from FIG. 2 and to preserve a change in case in the sequence being encoded. Code 7 implies a case shift before the base that is encoded. Code 7 also indicates an optional case shift after the encoded base. If the bit C in the code is a “1”, then there is a case shift after the base encoded. If the bit C in the code is a “0”, then there is no case shift after the base encoded.

Code 8 is usable to encode two bases, each as a four-bit value, and to preserve a change in case in the sequence being encoded. The “BASEBASE” in FIG. 5 indicates the two four-bit codes of the two bases being encoded. There is an implied case shift before each base, and an optional case shift after each encoded base. If the first bit C of the “CC’ is a “1”, then there is a case shift after the first base. If the first bit C of the “CC” is a “0”, then there is no case shift after the first base. Similarly, if the second bit C of the “CC’ is a “1”, then there is a case shift after the second base. If the second bit C of the “CC” is a “0”, then there is no case shift after the second base.

Code 9 directly encodes two bases. Each base is encoded as a two-bit code. The “BBBB” of the code in FIG. 5 indicates the two two-bit codes.

Code 14 directly encodes three bases. Each base is encoded as a two-bit code. The “BBBBBB” of the code in FIG. 5 indicates the three two-bit codes.

Code 10 is a code that does not encode any bases, but rather adds three extra bits (the “XXX”) to the length field N of the preceding code. This code is referred to as a “field extension code.” A field extension code that extends another field (such as the address field) of a preceding code, although not illustrated in FIG. 5, may be employed in other embodiments.

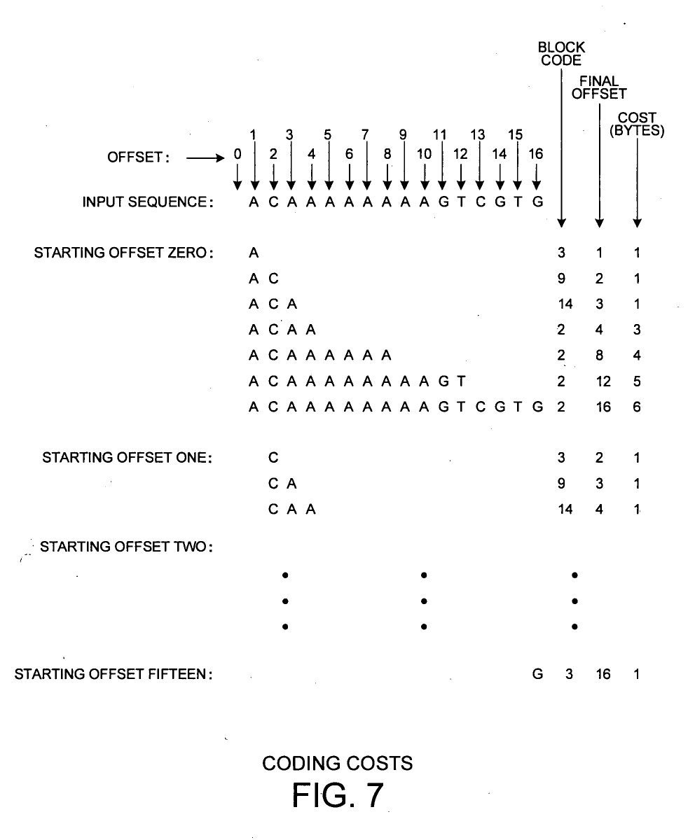

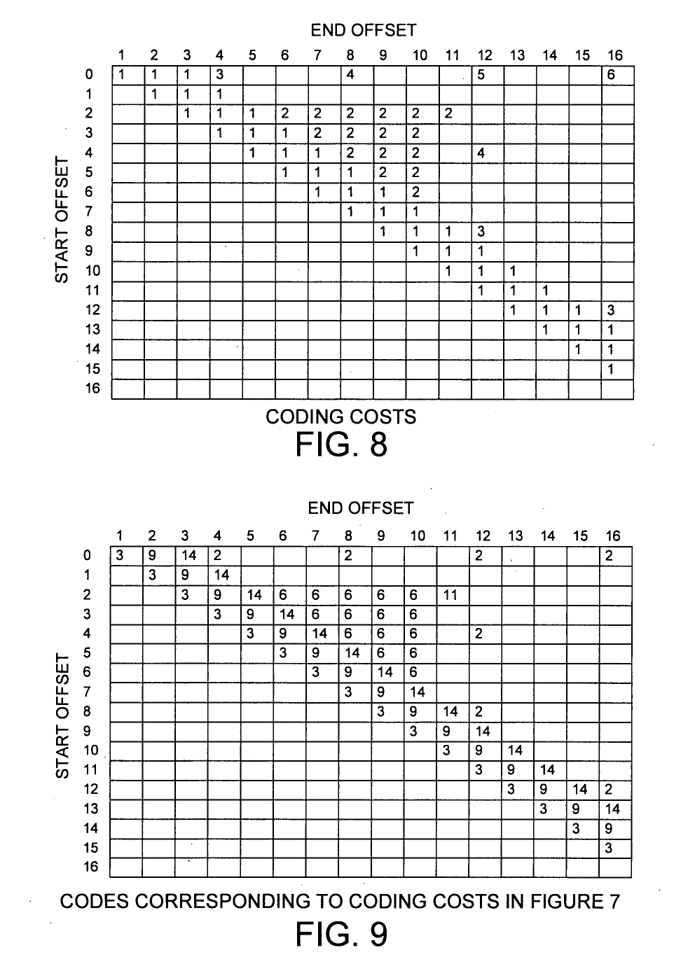

FIG. 7 is a diagram that illustrates an example of step 5 of FIG. 1. The diagram shows how various different possible ways to encode a sequence are determined. In the example of FIG. 7, the sequence to be encoded is the “INPUT SEQUENCE” of “ACAAAAAAAAGTCGTG”. First, starting at offset zero, a single base “A” can be encoded using block code 3. As indicated by the columns to the right of the diagram, if a single base is encoded starting at offset zero, then the final (ending) offset is one. Using code 3 consumes one byte as indicated by FIG. 5.

Next, starting at offset zero, the first two bases “AC” can be encoded using block code 9. As indicated in FIG. 7, if two bases are encoded starting at offset zero, then the final offset will be two. As indicated by FIG. 5, using block code 9 consumes one byte.

This process of attempting to encode more and more bases down the input sequence is repeated. If two different block codes can be used to encode the same base string, then the block code that consumes the smaller number of bytes is recorded. In the example of FIG. 7, there are no codes that are usable to encode base strings that end at offsets 5, 6, 7, 9, 10, 11, 13, 14, and 15.

This process is then repeated, assuming that the starting offset is offset one. The process is then repeated, assuming that the starting offset is offset two, and so forth.

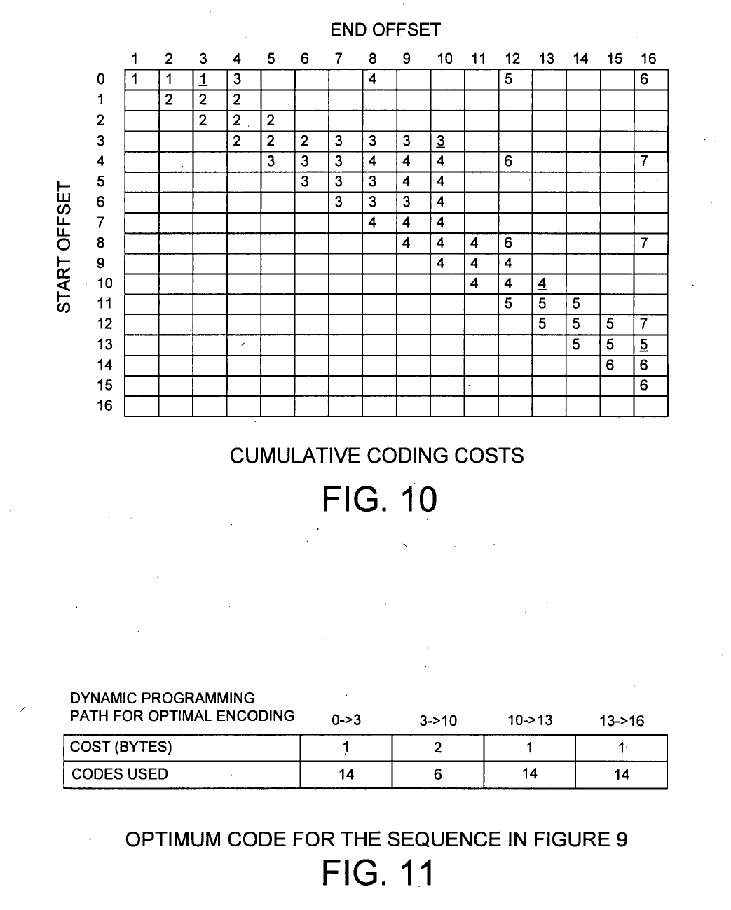

FIGS. 8 and 9 set forth the resulting information. FIG. 8 shows the coding costs in term of number of bytes. The upper left corner, for example, indicates that one byte is consumed to start at offset zero and to end at offset one. FIG. 9 indicates that the corresponding code used is code 3. The blanks in FIGS. 8 and 9 indicate offsets that cannot be reached.

Next in step 6 of FIG. 1, dynamic programming is used to determine the particular string of codes that will optimally encode the input sequence. First, the table of FIG. 10 is constructed to give the cumulative cost from the beginning of the sequence (start offset=0) to any final offset. Consider the block at the intersection of row zero (start offset zero) and column one (end offset one). The least costly way to code from offset zero to offset one is given by the corresponding block in the table of FIG. 8. It involves a single code 3 token as indicated in FIG. 9, and costs one byte as indicated in FIG. 8. The cost of one is therefore entered in the block of FIG. 10, at the intersection of row zero and column one.

Consider next the block at the intersection of row one (start offset one) and column two (end offset two). The entry in this block is to be the cheapest encoding from offset zero that will pass through offset one and end at offset two. There is only one set of codes that will accomplish this. The first code would code from offset zero to offset one (cost of one byte), and the second code would code from offset one to offset two (cost of one byte). The total cumulative cost is therefore two bytes. This cost value of two is entered into the block at the intersection of the row start offset one and the column end offset two.

Consider next the block at the intersection of row one (start offset one) and column three (end offset three). The entry in this block is to be the cheapest encoding from offset zero that will pass through offset one and end at offset three. One possible encoding is to use a first code to code from offset zero to offset one (cost of one byte), and to use a second code to code from offset one to offset three (cost of one byte). The costs of these two codes are set forth in the table of FIG. 8. The total cumulative cost is therefore two bytes. A second possible encoding is to use a first code to code from offset zero to offset one (cost of one byte), to use a second code to code from offset one to offset two (cost of one byte), and to use a third code to code from offset two to offset three (cost of one byte). The costs of these three codes are set forth in the table of FIG. 8. The total cumulative cost is therefore three bytes. This second possible encoding would therefore be more costly than the first possible encoding. Once all possible encoding paths from offset zero, through the start offset, and ending at the ending offset have been exhaustively examined, the cost of the least costly encoding path is entered in the block in FIG. 10.

Consider next the block at the intersection of row two (start offset two) and column three (end offset three). The entry in this block is to be the cheapest encoding from offset zero that will pass through offset two and end at offset three. One possible encoding is to use a first code to code from offset zero to offset one, to use a second code to code from offset one to offset two, and to use a third code to code from offset two to offset three. This path would have a cumulative cost of three bytes. A second possible encoding is to use a first code to code from offset zero to offset two, and to use a second code to code from offset two to offset three. This path would have a cumulative cost of two bytes. There is no way to get a cost less than two bytes, because the path requires the coding from offset two to offset three which must cost one byte. Accordingly, the lowest cumulative cost for the path from offset zero to offset three through offset two is two bytes. A two is therefore entered in to the appropriate block in FIG. 10.

This process of determining cumulative costs is repeated for all the blocks of FIG. 10. In each block, the entry indicates the lowest cost possible to code from offset zero and to get to a final offset going through a specified intermediary offset. All possible paths are examined to determine the lowest possible cost.

Once values in all of the blocks of the table of FIG. 10 have been determined, then dynamic programming is used to determine the lowest cost path from starting offset zero to ending offset sixteen. This is done starting at offset sixteen and asking what the cheapest path would be that would result at offset sixteen. The rightmost column of FIG. 10 indicates the cumulative costs for a number of different paths that end at offset sixteen. The lowest value in the rightmost column is a cost of five in the row corresponding to starting offset thirteen. The value in the block is therefore identified with an underline. It is determined that the least costly path to final offset sixteen must pass through offset thirteen.

Next, starting at offset thirteen, what would the cheapest path be that would result at offset thirteen? The column of FIG. 10 for ending offset thirteen contains the cumulative costs for a number of different ways to end at offset thirteen. The lowest value in this column is a cost of four in the row corresponding to starting offset ten. The value in the block is therefore identified with an underline.

Next, starting at offset ten, what would the cheapest path be that would result at offset ten? The column of FIG. 10 for ending offset ten contains the cumulative costs for a number of different ways to end at offset ten. The lowest value in this column is a cost of three in the row corresponding to starting offset three. The value in the block is therefore identified with an underline.

Lastly, starting at offset three, what would the cheapest path be that would result at offset three? The column of FIG. 10 for ending offset three contains the cumulative costs for a number of different ways to end at offset three. The lowest value in this column is a cost of one in the row corresponding to starting offset zero. The value in the block is therefore identified with an underline.

It is therefore determined that the least costly path to code from starting offset zero to ending offset sixteen involves passing through the blocks having entries that are underlined in the table of FIG. 10. The path involves a first code (code 14) that codes from offset zero to offset three, a second code (code 6) that codes from offset three to offset ten, a third code (code 14) that codes from offset ten to offset thirteen, and a fourth code (code 14) that codes from offset thirteen to offset sixteen. FIG. 11 illustrates the codes used and their associated costs. In this way, dynamic programming and block codes that refer to similar portions of other sequences are used together to determine a string of block codes for encoding the input sequence. This process is repeated one by one for each successive sequence of the database.

Next (step 7 of FIG. 1), as each sequence is coded, the resulting string of codes is combined with its corresponding sequence description. The result (step 8) is a compressed sequence database. The compressed sequence database may, for example, be stored as a single file called an “NP3 file.” The file begins with a header that: 1) identifies the file as an NP3 file, and 2) contains summary information. The summary information includes a count of the total number of sequences, a count of the total number of stored bases, and a pointer to the first file section. Each file section is prefixed with a short header. The short header contains summary information for that section, as well as pointers to the various parts of that section, such as code stream and sequence description lookup tables. These pointers facilitate random access to selected ones of the compressed sequences. Sequences having redundant strings that are referred to by codes in other sequences must be within the same block of the data within the NP3 file. In one embodiment, the size of the blocks is chosen to facilitate decoding and decompression in a specialized peripheral search engine.

FIG. 12 is a diagram of a system 200 that involves a specialized peripheral search engine 201 and a personal computer 202. The specialized peripheral search engine is not a general purpose computer and does not execute an operating system, nor does it execute multiple application layer programs. Rather, it is specialized hardware primarily dedicated to the task of decoding encoded biomolecular sequences and to searching for one or more query strings in the resulting decoded information. The decoding and searching is performed primarily in hardware using dedicated circuitry rather than being performed by software executing on a general purpose processor.

Personal computer 202 can retrieve sequence database information from an entity 203 that is accessible to the personal computer via a network 204. In the illustrated example, network 204 is the internet, and the entity 203 stores the GenBank database. Various research entities 205 and 206 contribute information to and use the sequence database information stored by entity 203. In one example, entity 203 stores GenBank sequence database information that is encoded and compressed in accordance with the novel byte-aligned block code dynamic programming method described above. Personal computer 203 retrieves this compressed sequence database information via network 204 and stores the compressed information in local mass storage (for example, a hard disc) 207 for future use.

In another example, entity 203 stores uncompressed GenBank sequence database information. Personal computer 202 retrieves the uncompressed sequence database information via network 204, and then compresses the sequence database information using the novel byte-aligned block code dynamic programming compression methods described above. Regardless of which example is used, an encoded and compressed sequence database is eventually present in mass storage 207 on personal computer 202. Mass storage 207 (for example, hard disc mass storage) is a computer-readable medium as is semiconductor memory within personal computer 202.

Personal computer 202 has high-speed ethernet interface circuitry 208. Similarly, specialized peripheral search engine 201 has high-speed ethernet interface circuitry 209. Encoded and compressed sequence database information 210 is streamed from hard disc 207, through interface 208, across one or more high-speed ethernet connections 211, to interface 209 and to other circuitry 212 on search peripheral 201. The compressed sequence database information is temporarily buffered on specialized peripheral search engine 201 and the semiconductor memory that performs this buffering and temporary storing function is referred to here as a computer-readable medium. Circuitry 212 is specialized circuitry that decodes the encoded sequence database information by reversing the encoding process described above. Block 9 of FIG. 1 illustrates this decoding and decompression step.

The resulting stream of decoded and uncompressed database information is then compared with a query string. In one embodiment, the DASH method described in U.S. patent application Ser. No. 11/019,807 is implemented in hardware circuitry (for example, field programmable gate arrays) on search peripheral 201. The user of personal computer 202 previously entered the query string using personal computer 202, and this query string was transferred to the circuitry 212 on search peripheral 201. Results 213 of the search are returned across the ethernet connections 211 to personal computer 202 for analysis by the user of the personal computer.

Although certain specific exemplary embodiments are described above in order to illustrate the invention, the invention is not limited to the specific embodiments. The block code and dynamic programming compression method is applicable to amino acid sequences as well as to nucleotide sequence. Accordingly, various modifications, adaptations, and combinations of various features of the described embodiments can be practiced without departing from the scope of the invention as set forth in the claims.

What is claimed is:

1. A method comprising:
(a) using block codes to encode a set of biomolecular sequences, wherein a first of the block codes encodes a portion of a first biomolecular sequence by pointing to a portion of a second biomolecular sequence that is identical to the portion of the first biomolecular sequence, wherein the first block code identifies the second biomolecular sequence and also identifies a location in the second biomolecular sequence.

2. The method of claim 1, further comprising:
(b) using dynamic programming to determine which one of a plurality of different strings of the block codes most efficiently encodes the first biomolecular sequence.

3. The method of claim 1, wherein the block codes used in (a) include a second block code, wherein the second block code is a run length code.

4. The method of claim 1, wherein the block codes used in (a) include a second block code, wherein the second block code points to a second portion of the second biomolecular sequence but wherein the second code does not explicitly identify the second biomolecular sequence but rather implicitly refers to the biomolecular sequence that was identified by the first block code.

5. The method of claim 1, wherein the block codes used in (a) include a second block code, wherein the second block code points to a location in the second biomolecular sequence, wherein the second block code includes a first pointer that identifies an entry in a table, and wherein the entry is a second pointer that points to the location.

6. The method of claim 1, wherein all the block codes have lengths that are multiples of one byte, wherein a string of the block codes encodes the first biomolecular sequence, and wherein all the block codes of the string are byte-aligned.

7. The method of claim 1, wherein the first block code includes a sequence number portion that identifies the second biomolecular sequence, wherein the first block code includes an address portion that identifies a location within the second biomolecular sequence, and wherein the first block code includes a length portion that indicates a length of the portion of the second biomolecular sequence.

8. The method of claim 1, wherein each biomolecular sequence of the set is encoded as a different string of the block codes, the method further comprising:
(b) communicating strings of the block codes that encode biomolecular sequences of the set from a personal computer, across one or more ethernet connections, to a specialized peripheral search engine;
(c) decoding the strings of the block codes to recover the biomolecular sequences that were encoded by the strings, wherein the decoding of (c) is performed by the specialized peripheral search engine; and
(d) using the recovered biomolelular sequences to search for a query string in the recovered biomolecular sequences, wherein the using of (d) is performed by the specialized peripheral search engine.

9. A set of block code data structures stored on a computer-readable medium, comprising:
a first block code data structure that encodes a first portion of a first biomolecular sequence by pointing to a first portion of a second biomolecular sequence that is identical to the first portion of the first biomolecular sequence; and
a second block code data structure that encodes a second portion of the first biomolecular sequence by pointing to a second portion of the second biomolecular sequence that is identical to the first portion of the first biomolecular sequence, wherein the second block code data structure does not explicitly identify the second biomolecular sequence but rather implicitly refers to the biomolecular sequence that was identified by the first block code data structure.

10. The set of block code data structures of claim 9, wherein the set further comprises:
a third block code data structure, wherein the third block code data structure is a run length code that encodes a run of nucleotide bases.

11. The set of block code data structures of claim 9, wherein the set of block code data structures encodes each of a plurality of biomolecular sequences as a string of block code data structures.

12. A set of block code data structures stored on a computer-readable medium, comprising:
a first block code data structure that encodes a portion of a first biomolecular sequence by pointing to a portion of a second biomolecular sequence, wherein the portion of the first biomolecular sequence is identical to the portion of the second biomolecular sequence; and
a second block code data structure that encodes a portion of a third biomolecular sequence as a run length code, wherein all the block code data structures of the set are byte-aligned.

13. The set of claim 12, wherein the first biomolecular sequence is encoded as a first string of block code data structures of the set, wherein the second biomolecular sequence is encoded as a second string of block code data structures of the set, wherein the third biomolecular sequence is encoded as a third string of block code data structures of the set, and wherein the first, second and third strings are stored on the computer-readable medium.


SEQUENCE LISTING (6 sequences)

SEQ ID NO: 1 - DNA, 12 bp, Artificial Sequence
  A hypothetical sequence used as an example
gcgcgcgcgcgc

SEQ ID NO: 2 - DNA, 16 bp, Artificial Sequence
  A hypothetical sequence used as an example
acaaaaaaaagtcgtg

SEQ ID NO: 3 - DNA, 16 bp, Artificial Sequence
  A hypothetical sequence used as an example
acaaaaaaaagtcgtg

SEQ ID NO: 4 - DNA, 4 bp, Artificial Sequence
  A hypothetical sequence used as an example
acaa

SEQ ID NO: 5 - DNA, 8 bp, Artificial Sequence
  A hypothetical sequence used as an example
acaaaaaa

SEQ ID NO: 6 - DNA, 12 bp, Artificial Sequence
  A hypothetical sequence used as an example
acaaaaaaaagt